(19) United States
(12) Patent Application Publication
(10) Pub. No.: US 2018/0101730 A1
(43) Pub. Date: Apr. 12, 2018

(54) MOBILE ELECTRONIC DEVICE AND SERVER

(71) Applicant: Chan-Shin WU, Taipei City (TW)

(72) Inventor: Chan-Shin WU, Taipei City (TW)

(21) Appl. No.: 15/729,672

(22) Filed: Oct. 11, 2017

(30) Foreign Application Priority Data
Oct. 12, 2016 (TW) 105132859

(51) Int. Cl. G06K 9/00; H04N 5/232; G06F 17/30

(52) U.S. Cl. CPC G06K 9/00671; H04M 2250/52; G06F 17/30256; H04N 5/23293

(57) ABSTRACT

The creation provides a mobile electronic device adapted for being connected to a server through a network. The mobile electronic device includes a lens, a wireless communication unit, a storing unit and a processing unit. The lens is adapted for taking a static picture. The wireless communication unit is adapted for being connected to the server through the network. The storing unit stores an object-identifying application. The processing unit is adapted for executing the object-identifying application. The object-identifying application analyzes and identifies the static picture by means of a database stored in the server. At least one related information of at least one identified object in the static picture is forwarded from the server back to the mobile electronic device.

### CROSS REFERENCE TO RELATED APPLICATIONS

This application is based on and claims the benefit of priority from the Taiwanese Patent Application No. 105132859 filed on Oct. 12, 2016, which are incorporated herein by reference.

### FIELD OF THE INVENTION

The present invention relates to an electronic device, and particularly relates to a mobile electronic device and a server.

### DESCRIPTION OF THE PRIOR ART

Due to technological advances, mobile electronic devices (for example, cell phones or tablets) have increasingly robust functions. When purchasing a mobile electronic device, consumers nowadays not only consider its call quality, Internet connection speed, operation efficiency of an executed application, and resolution of its display unit, but also attach great importance to its picture-taking performance. The picture-taking function of mobile electronic devices is one of the major functions consumers nowadays often need.

Due to the wide coverage of the Internet, ever-increasing bandwidth of the Internet, and ever-increasing Internet connection speed, it has become a routine for users using mobile electronic devices to surf the Internet with a view to accessing related information. Therefore, the extensive use of two major functions, namely picture taking and Internet connection, of mobile electronic devices is going to interest mobile device-related software providers in the near future.

### SUMMARY OF THE INVENTION

The present invention provides a mobile electronic device whereby users take pictures and/or surf the Internet to access related information.

The present invention provides a mobile electronic device adapted for being connected to a server through a network. The mobile electronic device comprises a lens, a wireless communication unit, a storing unit and a processing unit. The lens is adapted for taking a static picture. The wireless communication unit is adapted for being connected to the server through the network. The storing unit stores an object-identifying application. The processing unit is adapted for executing the object-identifying application. The object-identifying application analyzes and identifies the static picture by means of a database stored in the server. At least one related information of at least one identified object in the static picture is forwarded from the server back to the mobile electronic device.

The present invention provides another mobile electronic device comprising a lens, a storing unit and a processing unit. The lens is adapted for taking a static picture. The storing unit stores an object-identifying application and a database. The processing unit is adapted for executing the object-identifying application. The object-identifying application analyzes and identifies the static picture by means of the database and generates at least one related information of at least one identified object in the static picture.

In one embodiment of the present invention, the mobile electronic device further comprises a display unit adapted for displaying the static picture. The at least one related information of the at least one identified object in the static picture is displayed on the display unit when the at least one identified object in the static picture is selected.

In one embodiment of the present invention, the mobile electronic device further comprises a display unit adapted for displaying the static picture. The at least one related information of the at least one identified object in the static picture is displayed on the display unit immediately after the at least one related information is sent back to the mobile electronic device.

In one embodiment of the present invention, the mobile electronic device further comprises a display unit adapted for displaying the static picture. The at least one related information of the at least one identified object in the static picture is displayed on the display unit immediately after the at least one related information is generated.

In one embodiment of the present invention, the at least one related information is one of a name, a definition, a class, a use, and a uniform resource locator (URL).

In one embodiment of the present invention, at least a part of the at least one related information is presented in a foreign language.

In one embodiment of the present invention, the database comprises a plurality of sub-databases. One of the sub-databases is selected and used as a reference in analyzing and identifying the static picture.

In one embodiment of the present invention, the one of the sub-databases is selected according to a location attributed to the mobile electronic device and detected by a global positioning system.

The present invention further provides a server adapted for being connected to an electronic device through a network. The server comprises a storing unit and a processing unit. The storing unit stores an object-identifying application and a database. The server is adapted for receiving through the network a static picture stored in the electronic device. The processing unit is adapted for executing the object-identifying application. The object-identifying application analyzes and identifies the static picture by the database. At least one related information of at least one identified object in the static picture is sent back to the electronic device.

In one embodiment of the present invention, the at least one related information is one of a name, a definition, a class, a use, and a URL.

In one embodiment of the present invention, at least a part of the at least one related information is presented in a foreign language.

In one embodiment of the present invention, the database comprises a plurality of sub-databases. One of the sub-databases is selected and used as a reference in analyzing and identifying the static picture.

In one embodiment of the present invention, the one of the sub-databases is selected according to a location attributed to the electronic device and detected by a global positioning system.

### BRIEF DESCRIPTION OF THE DRAWINGS

FIG. 1 is a block diagram of a mobile electronic device and a server according to the first embodiment of the present invention.

FIG. 2A is a schematic view of a static picture taken by the mobile electronic device according to an embodiment of the present invention.

FIG. 2B is a schematic view where the static picture shown in FIG. 2A has been processed by the object-identifying application.

FIG. 3 is a block diagram of a mobile electronic device and a server according to the second embodiment of the present invention.

### DETAILED DESCRIPTION OF THE EMBODIMENTS

### First Embodiment

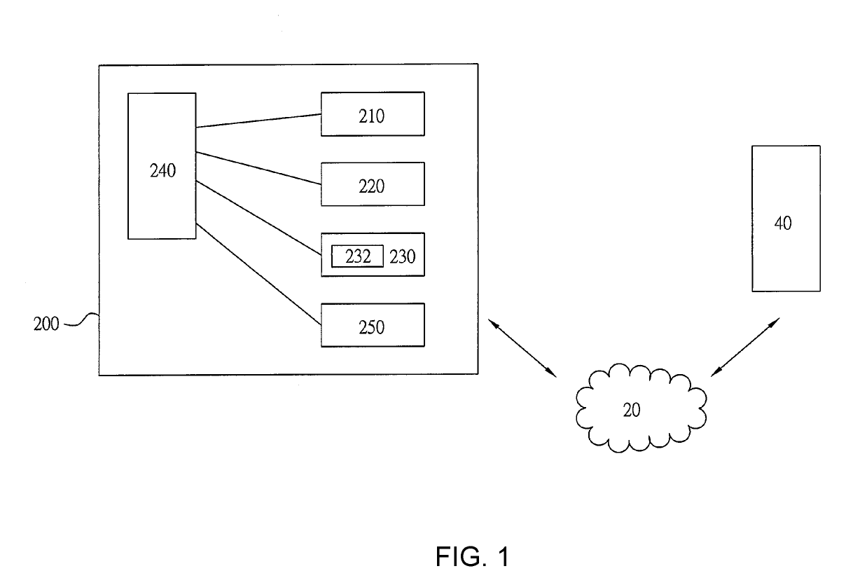

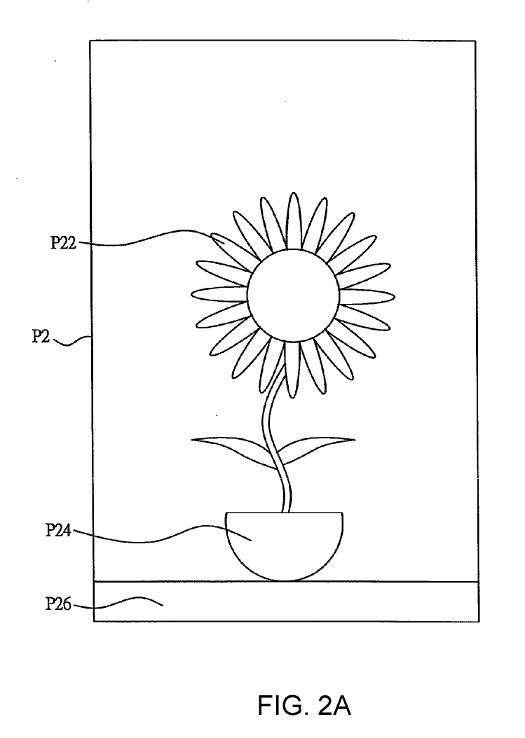

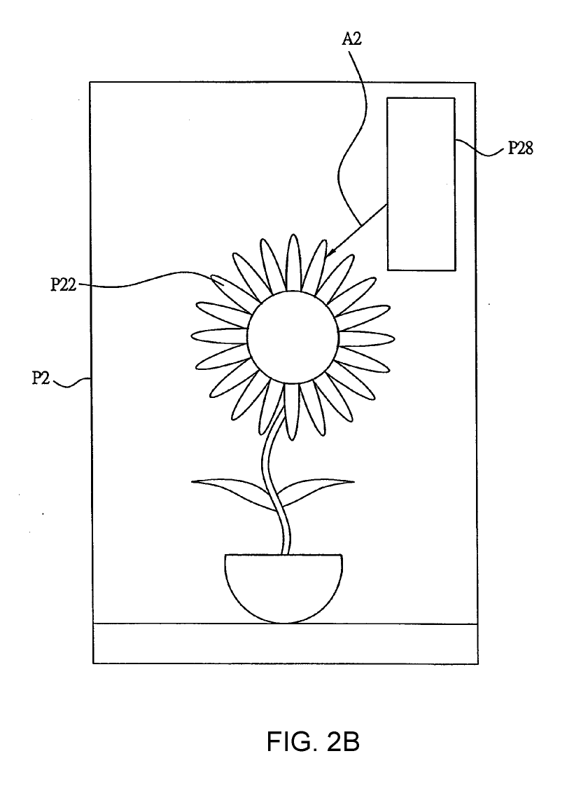

FIG. 1 is a block diagram of a mobile electronic device and a server according to the first embodiment of the present invention. Referring to FIG. 1, according to the present invention, a mobile electronic device 200 is adapted for being connected to a server 40 through a network 20. The mobile electronic device 200 comprises a lens 210, a wireless communication unit 220, a storing unit 230, a processing unit 240 and a display unit 250. A user can use the lens 210 to take a static picture P2 (shown in FIG. 2A). The display unit 250 is adapted for displaying the static picture P2. The wireless communication unit 220 is adapted for being connected to the server 40 through the network 20. The storing unit 230 stores a plurality of applications including an object-identifying application 232. The processing unit 240 is electrically connected to the lens 210, the wireless communication unit 220, the storing unit 230 and the display unit 250.

FIG. 2A is a schematic view of a static picture taken by the mobile electronic device according to an embodiment of the present invention. FIG. 2B is a schematic view where the static picture shown in FIG. 2A has been processed by the object-identifying application 232. Referring to FIG. 1, FIG. 2A and FIG. 2B, after the user uses the lens 210 to take the static picture P2, the static picture P2 can be displayed on the display unit 250 (which can be regarded as Step 1). The user can use a user interface (for example, a button or a touch panel not shown) of the mobile electronic device 200 to input a command so that the processing unit 240 executes the object-identifying application 232 stored in the storing unit 230 in order to load the static picture P2 (which can be regarded as Step 2). It should be noted that in another embodiment, Step 2 can be performed prior to Step 1. That is, in the other embodiment the user can firstly start the object-identifying application 232 and then use the lens 210 to take the static picture P2 such that the object-identifying application 232 can load the static picture P2 instantly.

Afterward, the object-identifying application 232 analyzes and identifies the static picture P2 with a database stored in the server 40. In this embodiment, the analyzing involves discriminating at least one object from the others in the static picture P2. In this embodiment, three objects, namely a flower P22, a flowerpot P24, and a table P26, shown in the static picture P2 are analyzed by the object-identifying application 232. In this embodiment, the identifying involves linking the at least one analyzed object in the static picture P2 to at least one related information. In this embodiment, the analyzed flower object in the static picture P2 is linked to three related information: a name (for example, sunflower), a definition (for example, shape and color of petals) and a use (for example, for decoration). Afterward, the at least one related information (for example, the three related information including the name, the definition and the use of the flower P22) of the at least one identified object (for example, the flower P22) in the static picture P2 is sent from the server 40 back to the mobile electronic device 200.

In another embodiment, the at least one related information can be a class or a URL (or a Website address). The class is, for example, an animal or plant group in the biological taxonomy. The Website is, for example, a dictionary Website (which can display examples of sentences), a video Website (which can include an ecological introduction of an environment of growth or a popularization introduction of industrial uses, or provide virtual reality experiences), or an encyclopedia Website (which can include academic articles). In addition, part of the at least one related information can be presented in a foreign language (for example, English). In another embodiment, part of the at least one related information can be read aloud by a voice generating unit of the mobile electronic device. In the present embodiment, the three objects, i.e., the flower P22, the flowerpot P24 and the table P26, shown in the static picture P2 are regarded as small things. In another embodiment, an analyzed and identified object can be a motion (for example, the motion of a pitcher stepping forward and raising his arm to throw a baseball) or a large object (for example, a church or a museum).

Referring to FIG. 1, FIG. 2A and FIG. 2B again, in this embodiment, after the at least one related information of the at least one identified object in the static picture P2 has been sent from the server 40 back to the mobile electronic device 200, the user can select (for example, by means of clicking on or circling) the at least one identified object (for example, the flower P22) in the static picture P2, and in consequence the at least one related information (for example, the three related information including the name, definition, and use of the flower P22) of the at least one identified object (for example, the flower P22) in the static picture P2 is shown within an information frame P28 displayed on the display unit 250. As shown in FIG. 2B, the related information can be presented to overlap the static picture P2 and point at a related object (as indicated by the arrow A2 shown in FIG. 2B). In another embodiment, the related information can be presented beside the static picture P2. The present invention is not restrictive of the way of presenting the related information. In this embodiment, for instance, if the flower P22 is a sunflower, its name-related information will be presented as “sunflower” followed by its scientific name “Helianthus annuus”. In another embodiment, the class of the sunflower can be further presented as Helianthus and as soon as the user clicks the scientific name “Helianthus annuus”, the voice generating unit of the mobile electronic device can read “Helianthus annuus” aloud such that the user can listen and learn to imitate the voice. In another embodiment, the mobile electronic device 200 can be connected to an outside device through wired or wireless connection. If the outside device is a sound box, the related information can be transferred to and spoken by the sound box. If the outside device is a projector, the related information and the static picture P2 can be transferred to and projected by the projector. If the outside device is a LCD, the related information and the static picture P2 can be transferred to and displayed by the LCD.

In another embodiment, after at least one related information of at least one identified object in the static picture P2 has been sent from the server 40 back to the mobile electronic device 200, the at least one related information (for example, the three related information including the name, the definition and the use of the flower P22) of the at least one identified object (for example, the flower P22) in the static picture P2 is immediately displayed on the display unit 250 without the user's selection. In another embodiment, a non-mobile electronic device may be substituted for the mobile electronic device 200. The static picture P2 may not be taken by the non-mobile electronic device and may be already stored in the non-mobile electronic device.

Related scenarios in practice are described below. From the perspective of sightseeing, when a tourist visit a place, the mobile electronic device 200 and its communication with the server 40 enable the tourist to access related information pertaining to a pictured object such as an ancient monument, a living creature or a thing so that the tourist can further know the surrounding environment and the local language. From an educational point of view, a student equipped with the mobile electronic device 200 can learn more efficiently without consulting such many books, not to mention that the student can gain further insight into the surrounding environment and the local language. Furthermore, regarding specific users, such as children, a specific database appropriate to them can be provided such that any complicated or excess related information is prevented from being displayed on the display unit 250. Moreover, a database designer can divide the database into different sub-databases according to different regions. The units of the regions can be countries and each sub-database can be a set of information pertaining to a specific country. The above-mentioned units according to which the database is divided can be changed according to the designer's need. In addition, according to the location attributed to the mobile electronic device 200 and detected by a global positioning system, the object-identifying application 232 of the mobile electronic device 200 can determine one of the region sub-databases stored in the server 40 is used as a reference in analyzing and identifying the static picture such that the analysis and identification of the static picture can be speeded up.

The aforesaid embodiments are exemplified and illustrated in a circumstance that the database is stored in the server 40 and real-time wireless communication occurs between the mobile electronic device 200 and the server 40. In another embodiment, a database can be download and stored in the mobile electronic device in advance so that the analysis and identification of the static picture P2 can be still performed only in the mobile electronic device even if poor wireless communication happened.

Based on the aforementioned, the picture-taking function and/or Internet connection function of the mobile electronic device as well as the analysis and identification of the static picture by the object-identifying application together enable the user to gain insight into the at least one related information of the at least one object in the static picture. In addition, the user can save the time of searching for related information regarding the static picture in the internet.

### Second Embodiment

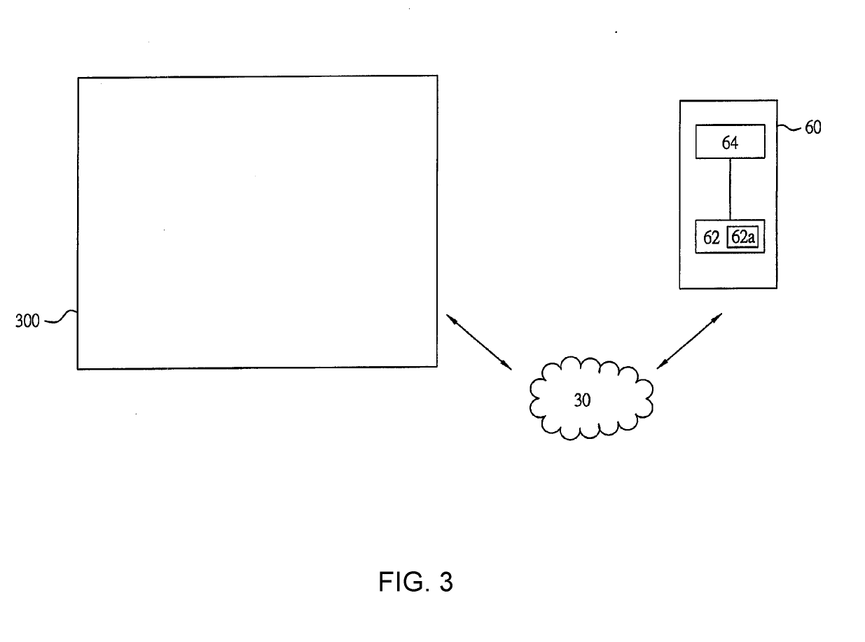

FIG. 3 is a block diagram of a mobile electronic device and a server according to the second embodiment of the present invention. The operational mechanism between a mobile electronic device 300 and a server 60 in the second embodiment is different from the operational mechanism between the mobile electronic device 200 and the server 40 in the first embodiment. In the second embodiment, an object-identifying application 62a is stored in a storing unit 62 of the server 60.

A user takes a static picture (not shown) with the mobile electronic device 300 and then uploads the static picture (not shown) to the server 60 through a network 30. A processing unit 64 of the server 60 executes the object-identifying application 62a. The object-identifying application 62a analyzes and identifies the static picture (not shown) by a database stored in the storing unit 62. At least one related information of at least one identified object in the static picture (not shown) is sent back to the mobile electronic device 300. For details of the way of displaying the related information on the mobile electronic device 300, please see the related description of the first embodiment above.

Based on the aforementioned, the mobile electronic device and the server of the present invention has following or another advantage. The picture-taking function and/or Internet connection function of the mobile electronic device as well as the analysis and identification of the static picture by the object-identifying application together enable the user to gain insight into the at least one related information of the at least one object in the static picture. In addition, the user can save the time of searching for related information regarding the static picture in the internet.

1. A mobile electronic device, adapted for being connected to a server through a network, comprising:
a lens adapted for taking a static picture;
a wireless communication unit adapted for being connected to the server through the network;
a storing unit for storing an object-identifying application; and
a processing unit adapted for executing the object-identifying application, wherein the object-identifying application analyzes and identifies the static picture by a database stored in the server, and at least one related information of at least one identified object in the static picture is sent from the server back to the mobile electronic device.

2. The mobile electronic device of claim 1, further comprising a display unit adapted for displaying the static picture, wherein the at least one related information of the at least one identified object in the static picture is displayed on the display unit when the at least one identified object in the static picture is selected.

3. The mobile electronic device of claim 1, further comprising a display unit adapted for displaying the static picture, wherein the at least one related information of the at least one identified object in the static picture is displayed on the display unit immediately after the at least one related information is sent back to the mobile electronic device.

4. The mobile electronic device of claim 1, wherein the at least one related information is one of a name, a definition, a class, a use, and a uniform resource locator (URL).

5. The mobile electronic device of claim 1, wherein at least a part of the at least one related information is presented in a foreign language.

6. The mobile electronic device of claim 1, wherein the database comprises a plurality of sub-databases, and one of the sub-databases is selected and used as a reference in analyzing and identifying the static picture.

7. The mobile electronic device of claim 6, wherein the one of the sub-databases is selected according to a location attributed to the mobile electronic device and detected by a global positioning system.

8. A mobile electronic device, comprising:
a lens adapted for taking a static picture;
a storing unit for storing an object-identifying application and a database; and
a processing unit adapted for executing the object-identifying application, wherein the object-identifying application analyzes and identifies the static picture by the database and generates at least one related information of at least one identified object in the static picture.

9. The mobile electronic device of claim 8, further comprising a display unit adapted for displaying the static picture, wherein the at least one related information of the at least one identified object in the static picture is displayed on the display unit when the at least one identified object in the static picture is selected.

10. The mobile electronic device of claim 8, further comprising a display unit adapted for displaying the static picture, wherein the at least one related information of the at least one identified object in the static picture is displayed on the display unit immediately after the at least one related information is generated.

11. The mobile electronic device of claim 8, wherein the at least one related information is one of a name, a definition, a class, a use, and a uniform resource locator (URL).

12. The mobile electronic device of claim 8, wherein at least a part of the at least one related information is presented in a foreign language.

13. The mobile electronic device of claim 8, wherein the database comprises a plurality of sub-databases, and one of the sub-databases is selected and used as a reference in analyzing and identifying the static picture.

14. The mobile electronic device of claim 13, wherein the one of the sub-databases is selected according to a location attributed to the mobile electronic device and detected by a global positioning system.

15. A server, adapted for being connected to an electronic device through a network, comprising:
a storing unit for storing an object-identifying application and a database; and
a processing unit;
wherein the server is adapted for receiving through the network a static picture stored in the electronic device, the processing unit is adapted for executing the object-identifying application, the object-identifying application analyzes and identifies the static picture by the database, and at least one related information of at least one identified object in the static picture is sent back to the electronic device.

16. The server of claim 15, wherein the at least one related information is one of a name, a definition, a class, a use, and a uniform resource locator (URL).

17. The server of claim 15, wherein at least a part of the at least one related information is presented in a foreign language.

18. The server of claim 15, wherein the database comprises a plurality of sub-databases, and one of the sub-databases is selected and used as a reference in analyzing and identifying the static picture.

19. The server of claim 18, wherein the one of the sub-databases is selected according to a location attributed to the electronic device and detected by a global positioning system.
